(19) United States
(12) Patent Application Publication
(10) Pub. No.: US 2017/0346824 A1
(43) Pub. Date: Nov. 30, 2017

(54) METHODS AND SYSTEMS FOR MOBILE DEVICE RISK MANAGEMENT

(71) Applicant: Tracker Networks Inc., Toronto (CA)

(72) Inventors: Roger Ramchand Mahabir, Toronto (CA); Jason Doel, Newmarket (CA); Mesbah Abdulrahem, Guelph (CA); Peter Grys, Richmond Hill (CA)

(21) Appl. No.: 15/168,353

(22) Filed: May 31, 2016

(51) Int. Cl. H04L 29/06; G06F 21/57

(52) U.S. Cl. CPC H04L 63/10; G06F 21/577; G06F 2221/034

(57) ABSTRACT

Mobile device risk management systems and methods are provided. The system has a risk assessment server in communication with a mobile device. A risk assessment application is installed on the mobile device and identifies applications installed thereon and application characteristics including at least one device-specific parameter. The risk assessment server determines application risk levels and a device risk level for the mobile device using the application characteristics. The risk assessment server provides the application risk levels and device risk levels to the mobile device to allow a user to manage device risk. The risk assessment server may control access to an organizational network using the device risk levels. An organizational risk assessment application may also be provided to an administrator terminal to allow a corporate user to control the settings of the risk assessment server. The risk assessment server may also determine corrective actions to reduce device risk levels.

### FIELD

The described embodiments relate to managing mobile device risks, and in particular to systems and methods for managing mobile device risk in a networked environment.

### BACKGROUND

As the number of mobile applications (apps) increases, understanding the risks of installing and using these apps becomes increasingly difficult. Users of mobile devices may not understand the nature or the level of risk that many apps represent to their personal privacy, identity and safety. An easy way of assessing and understanding the risks posed by apps installed on a mobile device may improve individual security and privacy.

Organizations are increasingly inheriting these risks from the mobile devices used by their employees or members. When an employee or member wishes to connect their mobile device to a corporate or organizational network or to install corporate apps on their personal phones (i.e. Bring-Your-Own-Device or BYOD), the risks posed by the apps installed on their mobile device may be transferred to the organizational network. Compromised mobile apps may be used to access confidential corporate information, gain unauthorized entry into sensitive networks and systems, record passwords, eavesdrop through microphones and cameras, and so on.

Despite these risks, BYOD policies are becoming increasingly prevalent in corporate environments. A younger, tech savvy generation of workers is demanding choice in the mobile devices they use; such workers generally do not want separate personal and corporate phones. Organizations may also realize cost savings by allowing workers to supply their own devices and by having users take better care of those devices because they feel personal ownership over those devices. However, BYOD policies place the burden on organizations to ensure that a variety of mobile devices, with a variety of apps installed thereon, do not impose undue risks to network security.

As with personal security and privacy of individual mobile devices, it is difficult to identify applications that pose security risks to an organizational network. Hundreds of thousands of apps are available, with new updates and apps being released every day. It may be unfeasible or unwieldy for organizations to manually assess and analyze the risks posed by each app, and each app update. Organizations may also not have the internal expertise and personnel required to perform this assessment. Furthermore, an organization may be required to support hundreds or thousands of mobile devices, such that manually tracking and assessing the risk associated with each device is not feasible.

### SUMMARY

In a first broad aspect, there is provided a method of controlling mobile device access to an organizational network. The method can include providing a risk assessment server for determining device risk, the risk assessment server can include a processor and a memory and be in communication with a plurality of mobile devices associated with the organizational network; providing a local risk assessment application to each of the mobile devices; for each of the mobile devices, determining by the local risk assessment application: a plurality of application identifiers, each application identifier identifying a mobile application installed on that mobile device; and a plurality of device-specific parameters, each device-specific parameter defining operational characteristics of at least one of the mobile device and an application on that mobile device. The method can also include receiving at the risk assessment server, from each mobile device, the plurality of application identifiers and the plurality of device-specific parameters determined by the local risk assessment application on that mobile device; for each mobile device, determining by the risk assessment server for each mobile application installed on that mobile device a plurality of application characteristics using the application identifiers, the application characteristics defining inherent operational characteristics of the mobile application; a plurality of application risk factors for that mobile application, the plurality of application risk factors including at least one inherent application risk factor determined from the application characteristics of that mobile application and at least one device-specific risk factor determined from the plurality of device-specific parameters; and an application risk level based on the plurality of application risk factors; and determining a device risk level for that mobile device based on the plurality of application risk levels determined for the mobile applications installed on that mobile device. The method can also include determining a network acceptable risk level; identifying at least one high-risk mobile device from the plurality of mobile devices, each high-risk mobile device having a device risk level greater than the network acceptable risk level; and controlling access to the organizational network by preventing each high-risk mobile device from accessing the organizational network.

In some cases, the at least one inherent application risk factor may be at least one of an application runtime behavior, an operating system interaction, a known application vulnerability, and an application communication pattern.

In some cases, the plurality of device-specific parameters may include at least one application permission setting defining a current permission for a particular mobile application on that particular mobile device.

In some cases, the at least one application permission setting can include a plurality of application permission settings and the at least one device-specific risk factor may be a high-risk combination of permissions that includes at least two application permission settings from the plurality of application permission settings.

In some cases, the at least one device-specific risk factor may be a high risk combination of one of the application permission settings and one of the application characteristics for the particular mobile application.

In some cases, the method may further include determining by the risk assessment server at least one corrective action for one of the high-risk mobile devices, the at least one corrective action being determined to reduce the device risk level for that high-risk mobile device to below the network acceptable risk level; and displaying the least one corrective action in the local risk assessment application for that high-risk mobile device.

In some cases, the at least one corrective action may include modifying an application permission setting for that high-risk mobile device.

In some cases, the method may further include identifying by the local risk assessment application on a particular mobile device an attempt to install a new mobile application; prior to installation of the new mobile application, determining by the local risk assessment application the application identifier of the new mobile application, and transmitting the application identifier to the risk assessment server; determining by the risk assessment server the plurality of application characteristics for the new mobile application; determining by the risk assessment server a plurality of potential application risk factors for the new mobile application based on the application characteristics for the new mobile application, and determining a potential application risk level based on the plurality of potential application risk factors; determining by the risk assessment server permissible device-specific parameters based on the plurality of potential application risk factors, the device risk level for that particular mobile device, and the network acceptable risk level; and displaying the permissible device-specific parameters for the new mobile application in the local risk assessment application on the particular mobile device.

In some cases, the method may further include identifying by the local risk assessment application a modification to at least one of an application identifier and a device-specific parameter on a particular mobile device; determining by the risk assessment server an updated device risk level for the particular mobile device based on the modification; determining that the updated device risk level is greater than the network acceptable risk level; and automatically triggering a network protection action for the particular mobile device, the network protection action at least partially restricting access to the organizational network for the particular mobile device while the updated device risk level is greater than the network acceptable risk level.

In some cases, the network protection action may include at least one of automatically removing a particular mobile application installed on the particular mobile device, automatically modifying an application permission setting for the particular mobile application, and removing access to the organizational network for the particular mobile device.

In some cases, the method may include providing an organizational risk assessment application to a remote administrator terminal; and receiving at the risk assessment server an indication of the network acceptable risk level in response to an input to the organizational risk assessment application.

In another broad aspect, there is provided a method of providing a risk assessment for a mobile device. The method can include providing a risk assessment server, the risk assessment server having a processor and a memory and being in communication with the mobile device; providing a local risk assessment application to the mobile device; determining by the local risk assessment application: a plurality of application identifiers, each application identifier identifying a mobile application installed on the mobile device; and a plurality of device-specific parameters, each device-specific parameter defining operational characteristics of at least one of the mobile device and an application on that mobile device. The method may also include receiving the plurality of application identifiers and the plurality of device-specific parameters at the risk assessment server; determining by the risk assessment server: for each mobile application installed on the mobile device, a plurality of application characteristics defining inherent operational characteristics of the mobile application, a plurality of application risk factors for that mobile application, the plurality of application risk factors including at least one inherent application risk factor determined from the application characteristics of that mobile application and at least one device-specific risk factor determined from the plurality of device-specific parameters, and an application risk level based on the plurality of application risk factors; and displaying in the local risk assessment application the plurality of application risk levels.

In still another broad aspect, there is provided a network access control system that can include a remote administrator computer for an organizational network; an organizational risk assessment application accessible to the remote administrator computer, the organizational risk assessment application configured to provide a user interface enabling a user of the remote administrator computer to define a network acceptable risk level for the organizational network; a risk assessment server connected to the remote administrator computer and to a plurality of mobile devices associated with the organizational network, the risk assessment server having a memory, at least one network interface, and a server processor coupled to the memory for electronic communication therewith; and a local risk assessment application installed on each of the mobile devices, the local risk assessment application having instructions for configuring a processor of the mobile device to determine a plurality of application identifiers, each application identifier identifying a mobile application installed on that mobile device; determine a plurality of device-specific parameters, each device-specific parameter defining operational characteristics of at least one of the mobile device and an application on that mobile device; and transmit the plurality of application identifiers and the plurality of device-specific parameters to the risk assessment server. The processor of the risk assessment server can be configured to determine, for each mobile device for each mobile application installed on that mobile device, a plurality of application characteristics, the application characteristics defining inherent operational characteristics of the mobile application; a plurality of application risk factors for that mobile application, the plurality of application risk factors including at least one inherent application risk factor determined from the application characteristics of that mobile application and at least one device-specific risk factor determined from the plurality of device-specific parameters; and an application risk level based on the plurality of application risk factors; a device risk level for that mobile device based on the plurality of application risk levels determined for the mobile applications installed on that mobile device. The server processor of the risk assessment server can be further configured to identify at least one high-risk mobile device from the plurality of mobile devices, each high-risk mobile device having a device risk level greater than the network acceptable risk level; and prevent each high-risk mobile device from accessing the organizational network.

In some cases, the at least one inherent application risk factor may include at least one of an application runtime behavior, an operating system interaction, a known application vulnerability, and an application communication pattern.

In some cases, the plurality of device-specific parameters may include at least one application permission setting defining a current permission for a particular mobile application on that particular mobile device.

In some cases, the at least one application permission setting may include a plurality of application permission settings and the at least one device-specific risk factor includes a high-risk combination of permissions that includes at least two application permission settings from the plurality of application permission settings.

In some cases, the at least one device-specific risk factor can include a high risk combination of one of the application permission settings and one of the application characteristics for the particular mobile application.

In some cases, the server processor of the risk assessment server can be further configured to determine at least one corrective action for one of the high-risk mobile devices, the at least one corrective action being determined to reduce the device risk level for that high-risk mobile device to below the network acceptable risk level; and the local risk assessment application may further include instructions for configuring the processor of the mobile device to display the least one corrective action in the local risk assessment application for that high-risk mobile device.

In some cases, the at least one corrective action includes modifying an application permission setting for that high-risk mobile device.

In some cases, the local risk assessment application may further include instructions for configuring the processor of the mobile device to identify an attempt to install a new mobile application on that mobile device; prior to installation of the new mobile application, determine the application identifier of the new mobile application and transmit the application identifier to the risk assessment server. The server processor of the risk assessment server may be further configured to determine the plurality of application characteristics for the new mobile application; determine a plurality of potential application risk factors for the new mobile application based on the application characteristics for the new mobile application; determine a potential application risk level based on the plurality of potential application risk factors; and determine permissible device-specific parameters based on the plurality of potential application risk factors, the device risk level for that particular mobile device, and the network acceptable risk level. The local risk assessment application may further include instructions for configuring the processor of the mobile device to display the permissible device-specific parameters.

In some cases, the local risk assessment application may further include instructions for configuring the processor of the mobile device to identify a modification to at least one of an application identifier and a device-specific parameter on a particular mobile device; the server processor of the risk assessment server may be further configured to determine an updated device risk level for the particular mobile device based on the modification; determine that the updated device risk level is greater than the network acceptable risk level; and automatically trigger a network protection action for the particular mobile device, the network protection action at least partially restricting access to the organizational network for the particular mobile device while the updated device risk level is greater than the network acceptable risk level.

In some cases, the network protection action may include at least one of automatically removing a particular mobile application installed on the particular mobile device, automatically modifying an application permission setting for the particular mobile application, and removing access to the organizational network for the particular mobile device.

### BRIEF DESCRIPTION OF THE DRAWINGS

A preferred embodiment of the present invention will now be described in detail with reference to the drawings, in which:

FIG. 1 is a block diagram of an organizational computer network system in accordance with an example embodiment;

FIG. 2 is a block diagram of a network access control system in accordance with an example embodiment;

FIG. 3 is a flowchart illustrating a method of controlling mobile device access to an organizational network in accordance with an example embodiment;

FIG. 4 illustrates an example mobile risk assessment application display in accordance with an example embodiment;

FIG. 5 illustrates an example mobile risk overview display in accordance with an example embodiment;

FIG. 6A illustrates an example application risk overview display in accordance with an example embodiment;

FIG. 6B illustrates an example application risk factor display in accordance with an example embodiment;

FIG. 6C illustrates an example device-specific parameter display in accordance with an example embodiment;

FIG. 6D illustrates an example application info display in accordance with an example embodiment;

FIG. 7 illustrates an example network risk overview display in accordance with an example embodiment;

FIG. 8 illustrates an example user-specific risk overview display in accordance with an example embodiment;

FIG. 9 illustrates an example application-specific risk overview display in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXEMPLARY EMBODIMENTS

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

Embodiments of the systems and methods described herein may facilitate risk management for mobile devices. In particular, embodiments of the systems and methods described herein may provide for increased awareness and a greater understanding of the risks that may be posed by applications installed on a user's mobile device. Embodiments of the systems and methods described herein may also provide an improved ability to account for risks posed by the device-specific parameters of a mobile device as well as the applications installed thereon.

The embodiments described herein may provide a more nuanced assessment of the risks posed to data that is stored on a mobile device, or is accessible to a mobile device. A more nuanced assessment of risks may in turn allow users to access and use a wider variety of applications while still mitigating risks to the mobile device, and to networks to which the mobile device is connected.

Mobile device users are frequently interested in new and improved apps that provide new and greater functionality. However, users also want to know the risk level posed by the apps that are installed or about to be installed on their mobile devices. If aware of the risks, users may take corrective measures in response to the risks identified. For instance, a survey conducted by the Pew Research Center in 2015 showed that 90% of users installing apps want to know how their data will be used by the app, 60% of users have chosen not to install an app that they believed would use too much of their personal information and 43% have uninstalled an app for the same reason. However, the true risk level of many apps often remains hidden from users and can be difficult to properly identify and assess.

Apps may pose risks to users in a variety of ways. For example, some apps may pose risks of identity theft if user identity information can be captured and secretly transmitted without the user's knowledge. Apps that can log keystrokes, take screen captures, or take over sensitive apps with financial data at the operating system level may pose risks of financial data theft. Some apps may be used to remotely eavesdrop on users by activating the mobile device microphone and transmitting audio recordings of conversations and other sounds that are within the vicinity of the device.

In some cases, mobile apps may be used to invade user privacy and steal valuable information by remotely activating rear and front-facing cameras in order to secretly record and transmit photos and videos of the user and the area around their device. Apps may also be used to secretly access and transmit data from the mobile device such as private and/or confidential documents, photos from the device picture galleries and the like. Such techniques could be used to compromise personal privacy as well as capture corporate information (e.g. capturing images of whiteboards, accessing corporate data on a mobile device).

In some cases, mobile apps may be used to track and even stalk users. For instance, location functions such as GPS may be used to track the location of a mobile device to within a few feet. In some cases, apps may install hidden code that can take over a mobile device and use it for nefarious purposes, such as transmitting illicit data and/or launching attacks on third parties.

Even where a mobile application is distributed by a trusted published, there is still a risk that the mobile application may be compromised at some point by hackers. Apps have shown to be notoriously easy to break into, with hackers having access to tools and how-to instructions that are readily available on the internet. Hackers may even reverse engineer an app in order to copy it, insert their own malicious code, and then republish it back into major app stores. Unsuspecting users may install the counterfeit app, believing it to be authentic and never knowing they have been compromised.

There are generally two groups of mobile application risk factors. Inherent application risk factors or inherent application vulnerabilities generally refer to inherent operational characteristics of a mobile application that can be risky or vulnerable. In many cases, these vulnerabilities may result from flaws in the design of the mobile application. In some cases, the normal operations of an application may also render the applications more prone to compromise, or may increase the impact of the application being compromised. Users of mobile devices typically have no way of assessing the relative strengths or weaknesses of the apps they have installed or are installing.

Once vulnerabilities are discovered in mobile applications, this information can spread quickly through the hacker community, particularly after an app has been widely downloaded. Thus, the risk level of a mobile application may change dynamically as new and different inherent risk factors and vulnerabilities are identified. As updates and new app versions are released, new inherent risk factors may also be present in the updated versions. These inherent risk factors along with the increasing number of apps users have installed make it difficult for individuals to continually monitor the risk level of their individual applications, and to take the necessary corrective actions in a time-sensitive manner.

Another group of risk factors are device-specific risk factors. Device specific risk factors generally refers to the operational characteristics of a mobile device and/or operational characteristics of a mobile application that can be specifically modified for an individual device. Thus, device specific risk factors are generally reflective of the behavior of the individual using a mobile device.

For instance, device specific risk factors may be determined based on the permissions granted to an app on a particular mobile device. While the app may initially request the same permissions when installed on each mobile device, the actual permissions granted to the app on a particular device may provide the device-specific risk factors. For example, some device specific risk factors may include, but are not limited to, granting permissions that are unsafe or unnecessary for the functions carried out by the application, installing a known application with predetermined risks, installing an application that interacts with an excessively deep level of the device operating system, installing an application that attempts to “root” or jailbreak the device, etc.

Unsuspecting users will often install apps by accepting all permission requests and without reading the fine print in privacy policies. Users may assume that apps are safe because they are provided within a third party app store and have been downloaded by thousands of other users. However, users may not realize how seemly innocuous permission settings may be combined together, with or without inherent app vulnerabilities, and used by hackers for damaging results. Thus the particular combination of permission settings on a particular device (or a particular combination of at least one permission setting and an inherent application characteristics) may provide device-specific risk factors. Similarly, other operational characteristics of the device may also combine with inherent application characteristics to provide device-specific risk factors. For instance, the type of device and/or the operating system of the particular device may provide device-specific risk factors for applications that may not exist when the application is installed on different devices, or devices using a different operating system.

Given the wide-range of potential risk factors, and the potential risks caused by combinations of seemingly innocuous device or application settings, it can be difficult for users to assess and monitor the true risk level of each of their apps. Thus, an improved system and method for providing an assessment of the true risk level of various apps, how that risk level could actually impact users, and corrective actions or practical steps that users can take to protect themselves may significantly improve mobile device security and privacy.

At least some of the embodiments described herein provide a risk assessment server in communication with one or more mobile devices. The risk assessment server can be used to monitor and assess risks associated with the mobile devices. In particular, the risk assessment server may determine application risk levels associated with mobile applications installed on the mobile devices. The risk assessment server can also be used to determine a device risk level for each mobile device.

A local risk assessment application can be provided to each of the mobile devices. The local risk assessment application and the risk assessment server can work in conjunction to determine the application risk levels for applications installed on a mobile device.

The local risk assessment application can determine a plurality of application identifiers for a particular mobile device. Each application identifier identifies a mobile application installed on that mobile device. Each application identifier can include a plurality of identifying characteristics of a mobile device application, such as the application name, version, build, or other characteristics that may be used to identify the particular application and its expected operational characteristics.

The local risk assessment application can also determine a plurality of device-specific parameters, each device-specific parameter defining operational characteristics of at least one of the mobile device and an application installed on the mobile device. The device-specific parameter can reflect operational aspects of a mobile application on a particular mobile device that may be altered by a user of the device, or may be different for different mobile devices. For example, the at least one device-specific parameter can include a permission setting defining a current permission setting for a particular mobile application on that mobile device. The device-specific parameters may also include general device settings such as whether location services (e.g., cellular/GPS) are activated, and whether the device is jailbroken or rooted for example.

The local risk assessment application may communicate directly with the device operating system of the mobile device on which it is installed. This may allow the local risk assessment application to determine the application identifiers for the plurality of mobile applications installed on the mobile device. Similarly, this may allow the local risk assessment application to determine the device-specific parameters for the mobile device on which it is installed, such as the permission settings granted to the mobile device applications and whether location services are activated for example.

The local risk assessment application can transmit the plurality of application identifiers and the device-specific parameters to the risk assessment server. The risk assessment server can determine a plurality of application characteristics for each of the mobile applications installed on the device using the application identifiers. For example, the risk assessment server may store application characteristics corresponding to a plurality of different mobile applications. The application identifiers can be used to identify the correct application characteristics stored on the risk assessment server. In some cases, the risk assessment server may use the application identifiers to retrieve a copy of the mobile application for further analysis of application characteristics, such as code analysis or analysis of runtime behaviors.

Application characteristics generally define inherent operational characteristics of a mobile application. That is, the application characteristics generally relate to the operations of a mobile application that are inherent to the mobile application and may be similar across various mobile devices on which the application is installed.

The application characteristics may include an application communication pattern. An application communication pattern generally refers to the receiving locations (e.g., IP addresses) that an app normally communicates with, and may also include the type of data transmitted to particular IP addresses. The application characteristics may also include an operating system interaction level. The operating system interaction level generally refers to the level of device OS that the app is interacting with.

The application characteristics may also include application runtime behavior. For instance, the application runtime behaviors may include the use of dynamic URIs. Dynamic URIs may appear normal when an app is initially assessed, but may change dynamically to start communicating with a malicious server during runtime.

The risk assessment server can then determine application risk factors for the mobile applications installed on a mobile device. These application risk factors can be used to determine the application risk level for a particular mobile application installed on a particular mobile device.

The application risk factors can include inherent application risk factors and device-specific risk factors. Inherent application risk factors may be determined based on the application characteristics of a mobile application. For example, the inherent risk factors may include an application communication pattern with communications to receiving locations known to be malicious or comprised. The inherent risk factors may also include a particular operating system interaction level, as compromised apps will often communicate at a dangerously low level.

The device-specific risk factors may be determined based on the device-specific parameters for the mobile device. In some cases, the device-specific risk factors may also take into account the application characteristics of the mobile application. For example, the device-specific risk factor may be determined based on a high risk combination of application permission settings granted to a particular application and/or a high risk combination of an application permission setting and an application characteristics for a particular application.

The risk assessment server can then determine the application risk levels for the various mobile application based on the application risk factors. The various application risk factors for a particular application can be weighted based on both the individual risk factors, and combinations of risk factors. The weighting may take into account known hacking techniques that have been used to trick users into taking actions that lead to their device being compromised.

The application risk levels can be provided to the mobile devices. The local risk assessment application can display the application risk levels to the user of the mobile device so the user is aware of the risks posed by applications installed on the mobile device. In some cases, a potential application risk level may be provided before installation of a mobile application (or during the installation process) to allow a user to make an informed choice about whether to install of the mobile application.

The risk assessment server may also determine a device risk level for a mobile device. The device risk level may be determined based on the application risk levels for that mobile device. The device risk level may be displayed in the local risk assessment application to inform a user of the level of risk their mobile device is currently exposed to.

The risk assessment server may also determine a corrective action for a mobile device. The corrective action may be determined in order to reduce the device risk level for the mobile device. In some cases, the corrective action may be determined to reduce the application risk level for one or more mobile application installed on the mobile device. For example, corrective action may be determined to reduce the application risk level for one or more mobile applications having the highest risk level on a particular mobile device. In some cases, the corrective action may be removing the risky mobile application or modifying the application permission setting for a mobile application.

The corrective action can be displayed to a user in the local risk assessment application on their mobile device. The corrective action may be displayed along with the application risk level and/or the device risk level. Additional information, such as the nature of the risk, and the potential dangers that may be mitigated or avoided by the corrective action may also be displayed in the local risk assessment application. This may provide a user with greater information regarding the risks to be avoided, and allow the user to take ownership over the risk level of their device.

In some cases, the local risk assessment application may also monitor device behavior on an ongoing basis. This may allow the local risk assessment application to identify risky user behaviors. Risky user behaviors generally refers to active steps taken by a user of the mobile device that may be risky, or may be risky in combination with other application risk factors. For example, the local risk assessment application may determine that the mobile device is located near to, or is in communication with networks in regions known to be more likely to be compromised. For example, the local risk assessment application may determine that the device is in communication with, or near to, cell networks that have been compromised. Risky user behaviors may also include actions such as the user accessing web locations using the device browser that may be compromised.

The local risk assessment application may warn a user if they are engaging in risky user behaviors, such as travelling to areas or regions where cellular data or data traffic is not as safe. The local risk assessment application may suggest corrective actions, such as adjusting device-specific operating parameters while the risky user behavior is occurring, that may mitigate the risks of the risky user behaviors.

Embodiments described herein can also provide an improved system and method for monitoring mobile device risk within an organizational network. The systems and methods described herein may also be used to control mobile device access to the organizational network. In general, the embodiments described above may be implemented within the framework of an organizational network. The risk assessment server and local risk assessment application may provide risk management on the device level, while an organizational risk management application may be used to administrate the operation of the risk assessment server, configure the manner in which the risk assessment server controls access to the organizational network.

Organizations and corporations may inherit the risks associated with mobile applications when users wish to connect their devices to corporate networks or to installing corporate apps on the personal phones of employees (i.e. Bring-Your-Own-Device or BYOD). However, organizations are under pressure to support BYOD policies and may realize cost savings by allowing users to provide their own mobile devices.

As a result, organizations may need to oversee the risks on users' mobile devices to prevent risks to the organizational network. Given the large number of applications and mobile devices that may need to be monitored, this process can be overwhelming for some organizations and may not represent an optimal use of resources. Further, users may have some expectation of privacy (legal or otherwise) in regard to the apps and data on their personal devices. Thus, organizations may be limited in the information they obtain about a user's mobile device. In addition, any private data acquired by the organization may impose obligations on the organization to protect the user's data and privacy.

As explained above, a risk assessment server can be provided to monitor and access risks associated with the apps on a user's mobile device. The risk assessment server may also be coupled to the organizational network, and may control device access to the organizational network. For example, the risk assessment server may determine a network acceptable risk level for the organization network. This acceptable risk level may be determined as a default setting, or modified by an administrator in the organization, such as the organization's security or IT departments. The risk assessment server may identify mobile devices as high risk when the device risk level is greater than the network acceptable risk level. The risk assessment server may then prevent high-risk mobile devices from accessing the organizational network.

The embodiments described herein may also include one or more administrator computers coupled to the risk assessment server. The administrator computer may access to an organizational risk assessment application. The administrator computer may have the organizational risk assessment application installed thereon, or it may be accessible as a Software-as-a-Service (SaaS) application available over a network, e.g., provided by the risk assessment server. The organizational risk assessment application may provide a portal for an administrator of the organization to control the level of acceptable risk for the organizational network.

In some cases, the risk assessment server can provide to the administrator computer through the organizational risk assessment application user identifiers and associated device risk levels. The risk assessment server may also identify the number of high risk applications installed on the mobile device associated with each user. The organizational risk assessment application may permit the network administrator to allow a high-risk mobile device to access the network and/or restrict access to various regions of the network. For instance, access to region of the network storing crown jewel data may be limited to mobile devices having a low device risk level.

The organizational risk assessment application may permit the network administrator to establish organizational rules for controlling access for devices at the various risk levels. The organizational rules may be implemented automatically by the risk assessment server to minimize the amount of manual intervention required to control access to the organizational network. This may also allow the risk assessment server to rapidly and automatically respond to changes in device risk levels, for instance by disconnecting a device from the organizational network if the device risk level has changed to high. In some cases, the risk assessment server may interface with other mobile device management systems an organization has in place to automatically trigger network protection actions, such as disconnecting devices from the network.

The risk assessment server may also identify a plurality of risk levels, e.g. low-risk medium-risk, high-risk, etc. The organizational risk assessment application may permit a network administrator to establish organizational rules for each of the risk levels in the plurality of risk levels. For example, high risk devices may be excluded from accessing the network, low-risk devices allowed to access the network, while medium risk devices are presented in the organizational risk assessment application for approval before accessing the network.

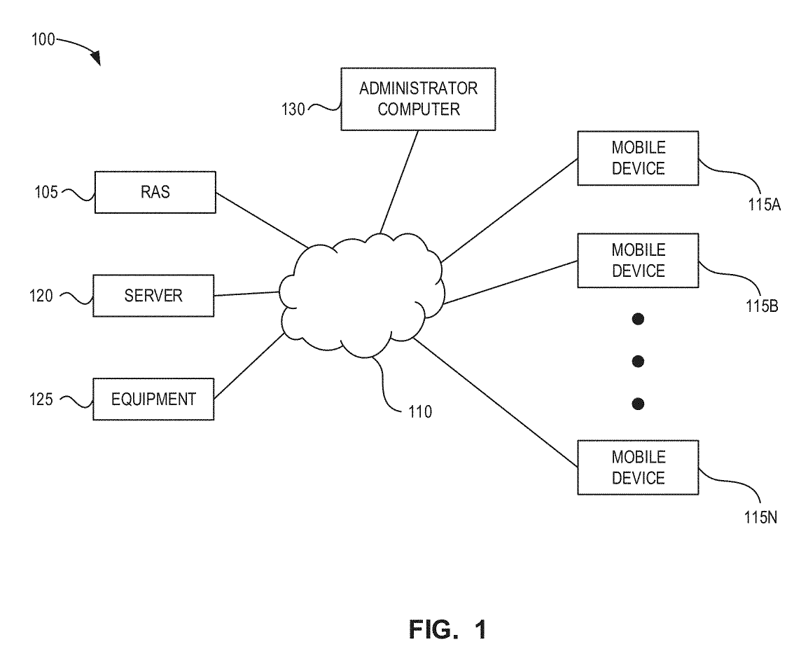

Referring now to FIG. 1, there is provided is a block diagram of an organizational computer network system 100 in accordance with an example embodiment.

Computer network system 100 generally comprises a plurality of computers connected via data communication network 110, which itself may be connected to the Internet. In general, however, the computer network system includes a risk assessment server (RAS) 105, an administrator computer 130, and a plurality of mobile devices 115A-115N connected via network 110.

Typically, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Computers and computing devices may be connected to network 110 or a portion thereof via suitable network interfaces. Computing devices may also encompass any connected or “smart” devices capable of data communication, such as thermostats, air quality sensors, industrial equipment and the like. Increasingly, this encompasses a wide variety of devices as more devices become networked through the “Internet of Things”. In some cases, one or more of the computing devices such as the mobile devices 115 may connect to network 110 via the Internet.

Examples of computers include the remote administrator computer 130, such as a desktop or laptop computer, which can connect to network 110 via a wired Ethernet connection or a wireless connection. The remote administrator computer 130 may also connect to the network 110 via the Internet. Remote administrator computer 130 has a processor, volatile memory and non-volatile storage memory, at least one network interface, input devices such as a keyboard and trackpad, output devices such as a display and speakers, and various other input/output devices as will be appreciated.

Similarly, mobile devices 115 generally refer to a smartphone or tablet computer, however mobile devices 115 may also include a wide variety of “smart” devices capable of data communication. Like computer 130, mobile device 115 has a processor, volatile and non-volatile memory, at least one network interface, and input/output devices. Mobile device 115 is typically portable, and may at times be connected to network 110 or a portion thereof.

Networked equipment 125 is an example computing device that may be an industrial machine, facilities equipment, sensor, or any other machine that is connected to network 110. Networked equipment 125 has a processor, such as a microcontroller, a memory that may include volatile and non-volatile elements, and at least one network interface. Optionally, networked equipment 125 may include additional input or output devices, although this is not required for some types of equipment.

Server 120 is a computer server that is connected to network 110. Like computer 130, server 120 has a processor, volatile and non-volatile memory, at least one network interface, and may have various other input/output devices. As with all devices shown in computer network system 100, there may be multiple servers 120, although not all are shown.

Some of the servers 120 may store or otherwise have access to crown jewel data. Crown jewel data refers to data that can significantly harm the organization if it has been viewed, stolen, changed, deleted or otherwise used without permission by an unauthorized individual. Crown jewel data may be initially identified in a manual process, for example, by organizational managers.

Each of the computers and computing devices may at times connect to external computers or servers via the Internet. For example, server 120 may be an e-mail server that connects to a third-party e-mail server, or networked equipment 125 may connect to a software update server to obtain the latest version of a software application or firmware.

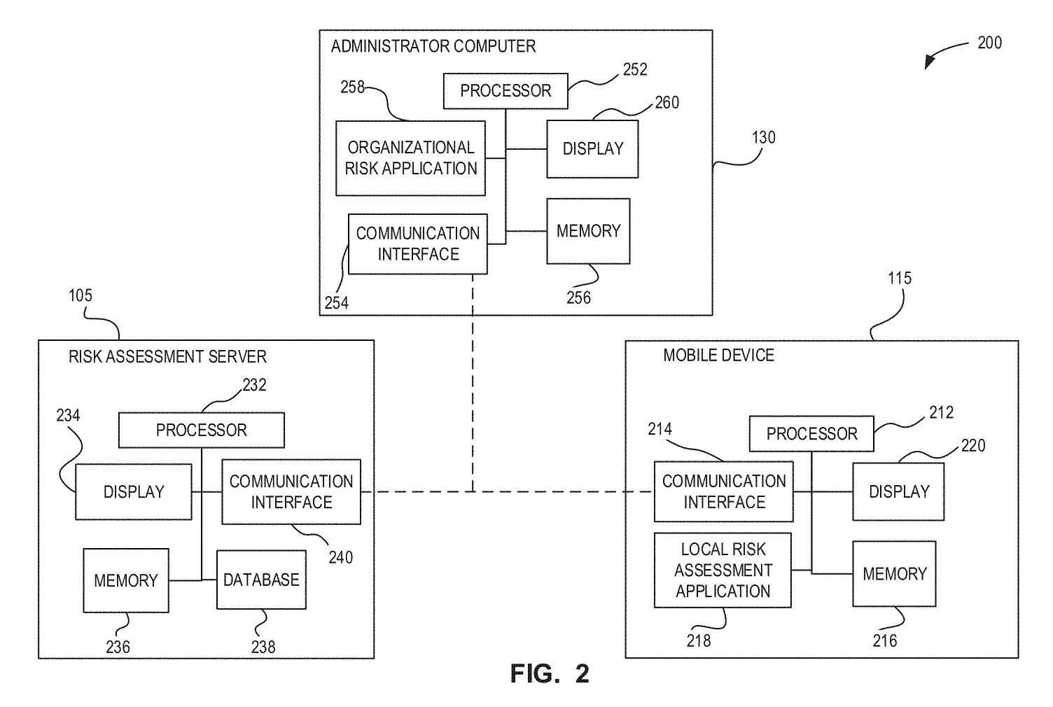

Risk assessment server 105 is a computer or computer server, and has a processor, volatile and non-volatile memory, at least one network interface, and may have various other input/output devices. As shown, risk assessment server 105 is linked to network 110. However, in other embodiments, risk assessment server 105 may be outside network 110 and linked to the Internet. The risk assessment server 105, administrator computer 130 and mobile device 115 are described in greater detail with reference to FIG. 2 below.

Risk assessment server 105 may be configured to control access to network 110, and/or access to one or more servers 120 via network 110. For instance, risk assessment server 105 may restrict access to servers 120 storing confidential or important data, such as crown jewel data.

As used herein, the term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled.

The software application may be associated with an application identifier that uniquely identifies that software application. In some cases, the application identifier may also identify the version and build of the software application. Within an organization, a software application may be recognized by a name by both the people who use it, and those that supply or maintain it. Mobile applications or “apps” generally refers to software applications for installation and use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs. For example, for many organizations, important applications and services rely on regular input from spreadsheets that may be obtained from third parties, so these spreadsheets may be identified as software applications.

Referring now to FIG. 2, there is shown a block diagram of a risk assessment system 200 in accordance with an example embodiment. Risk assessment system 200 is constructed from risk assessment server (RAS) 105, an administrator computer 130 and at least one mobile device 115. In some cases, the administrator computer 130 may be omitted from risk assessment system 200. The administrator computer 130 may be omitted, for instance, where the risk assessment server 105 is used to provide a risk assessment for one or more individual mobile devices 115 independent of an organizational network. In some other cases, the administrator computer 130 and RAS 105 may be integrated or co-located.

RAS 105 may be directly linked to administrator computer 130, for example, via a Universal Serial Bus, Bluetooth™ or Ethernet connection. Alternatively, RAS 105 may be linked to administrator computer 130 via network 110 or, in some cases, the Internet. RAS 105 may also be linked to mobile devices 115 via network 110 or, in some cases, the Internet.

RAS 105 has a processor 232, a display 234, a memory 236, a communication interface 240 and a database 238. Although shown as separate elements, it will be understood that database 238 may be stored in memory 236.

Processor 232 is a computer processor, such as a general purpose microprocessor. In some other cases, processor 232 may be a field programmable gate array, application specific integrated circuit, microcontroller, or other suitable computer processor.

Processor 232 is also coupled to display 234, which is a suitable display for outputting information and data as needed by various computer programs. In particular, display 234 may display a graphical user interface (GUI). In some cases, the display 234 may be omitted from risk assessment server 105, for instance where the risk assessment server 105 is configured to operate autonomously. In such cases, the RAS 105 may be configurable using a computer such as the administrator computer 130 that is connected to the RAS 105. RAS 105 may execute an operating system, such as Microsoft Windows™, GNU/Linux, or other suitable operating system.

Communication interface 240 is one or more data network interface, such as an IEEE 802.3 or IEEE 802.11 interface, for communication over a network.

Processor 232 is coupled, via a computer data bus, to memory 236. Memory 236 may include both volatile and non-volatile memory. Non-volatile memory stores computer programs consisting of computer-executable instructions, which may be loaded into volatile memory for execution by processor 232 as needed. It will be understood by those of skill in the art that references herein to RAS 105 as carrying out a function or acting in a particular way imply that processor 232 is executing instructions (e.g., a software program) stored in memory 236 and possibly transmitting or receiving inputs and outputs via one or more interface. Memory 236 may also store data input to, or output from, processor 232 in the course of executing the computer-executable instructions. As noted above, memory 236 may also store database 238.

In some example embodiments, database 238 is a relational database. In other embodiments, database 238 may be a non-relational database, such as a key-value database, NoSQL database, or the like.

The memory 236 on RAS 105 may store a software application referred to herein as a mobile application risk engine. The mobile application risk engine may be configured to determine application risk levels associated with mobile applications installed on mobile device 115, and to determine an overall device risk level for the mobile device 115. The mobile application risk engine may be stored on RAS 105, rather than directly on the mobile device 115 to prevent the risk engine from potentially being compromised when on a mobile device 115.

Mobile device 115 is generally a mobile computer such as a smartphone or tablet or other “smart” device that may be networked through the “Internet of Things”. Mobile device 115 has a processor 212, a communication interface 214 for data communication with communication interfaces 240 and 254, a display 220 for displaying a local risk assessment GUI, and a memory 216 that may include both volatile and non-volatile elements. As with RAS 105, references to acts or functions by mobile device 115 imply that processor 212 is executing computer-executable instructions (e.g., a software program) stored in memory 216.

For instance, a local risk assessment application 218 may be stored on the mobile device 115. Although shown separately from memory 216, it will be understood that local risk assessment application 218 may be stored in memory 216. The local risk assessment application 218 may communicate with the mobile application risk engine of RAS 105 to assist the RAS 105 in determining the application risk levels and device risk levels.

The local risk assessment application 218 may monitor mobile app data relating to mobile applications installed on the mobile device 115. The mobile app data may include application identifiers identifying the apps installed on mobile device 115. Each application identifier may include one or more identifying characteristics corresponding to a particular app installed on the mobile device 115. The local risk assessment application 218 may also identify device-specific parameters of the mobile device 115. The local risk assessment application 218 may transmit the application identifiers and device-specific parameters to the RAS 105.

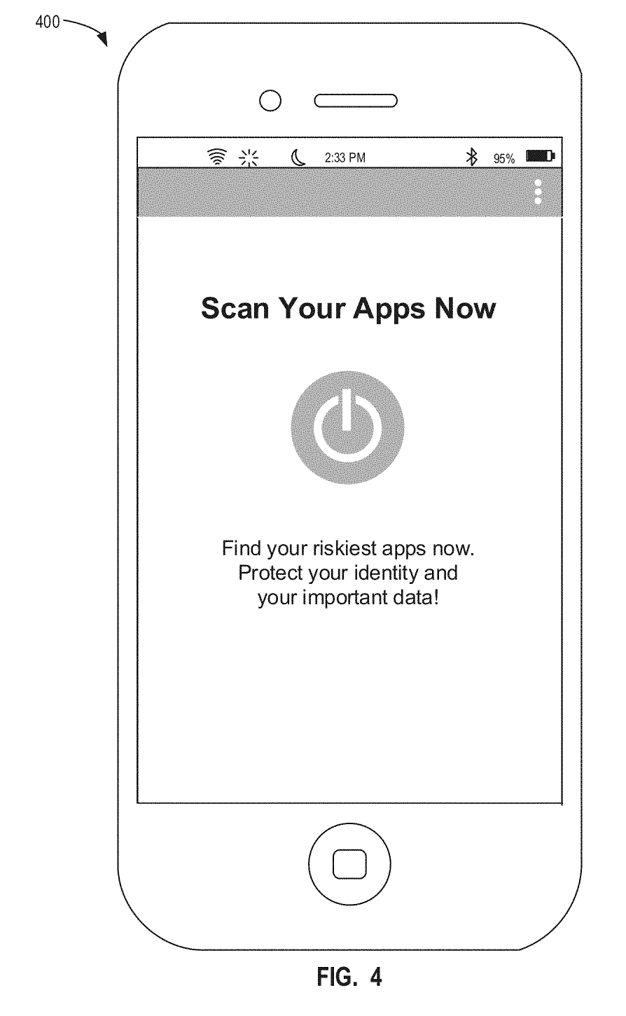

The RAS 105 may use the application identifiers to determine application characteristics for the various applications installed on mobile device 115. The RAS 105 may then determine application risk levels, and in turn device risk levels using the application characteristics and device-specific parameters. The RAS 105 can communicate the application risk levels and device risk level to the mobile device 115 for display using the local risk assessment application 218. Examples of graphical user interfaces that may be displayed by local risk assessment application 218 using display 220 are discussed below with references to FIGS. 4, 5, 6A-6D.

Administrator computer 130 is generally a computer similar to risk assessment server 105. The administrator computer 130 has a processor 252, a communication interface 254 for data communication with communication interfaces 220 and 240, a display 260 for displaying a local risk assessment GUI, and a memory 256 that may include both volatile and non-volatile elements. As with RAS 105, references to acts or functions by administrator computer 130 imply that processor 252 is executing computer-executable instructions (e.g., a software program) stored in memory 256.

An organizational risk assessment application 258 may be stored on the administrator computer 130. Although shown separately from memory 256, it will be understood that local risk assessment application 258 may be stored in memory 256. The organizational risk assessment application 258 may communicate with the mobile application risk engine of RAS 105 to configure network acceptable risk levels, and other settings of the mobile application risk engine. Although the organizational risk assessment application 258 is shown as installed on administrator computer 130, the organizational risk assessment application 258 may be otherwise accessible to the administrator computer 130 for instance as a cloud application accessible to the administrator 130 over a network such as the Internet.

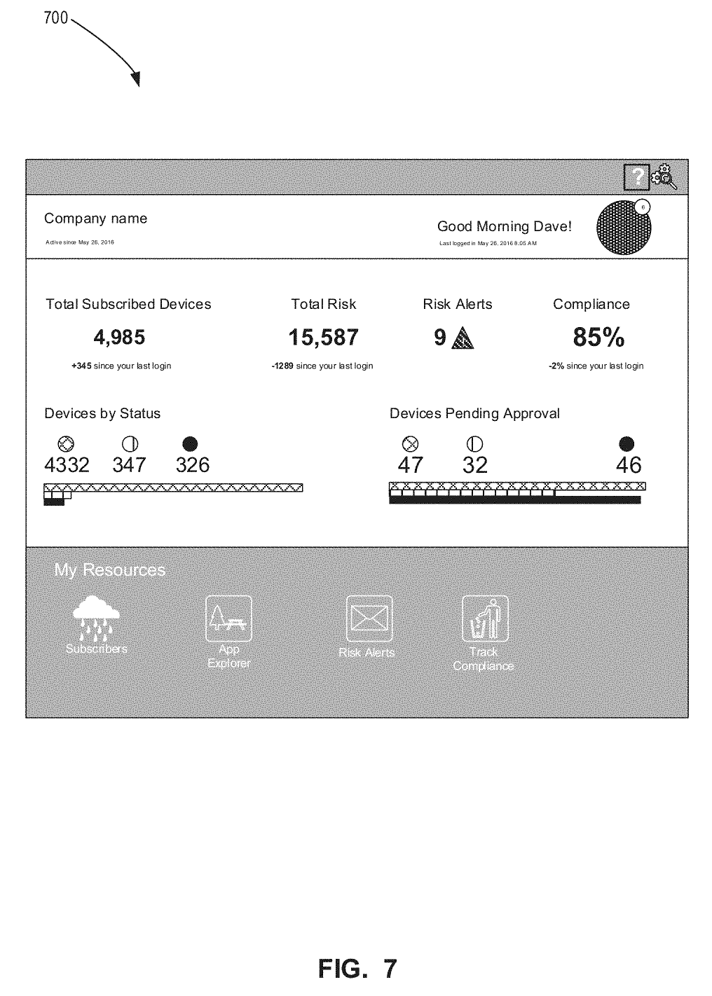

The RAS 105 may also communicate application risk levels and device risk levels for mobile devices 115 associated with an organizational network to the organizational risk assessment application 258. The organizational risk assessment application 258 may provide graphical user interfaces to allow an administrator of the organizational network to review application risk levels and device risk levels and requests to access the network. The organizational risk assessment application may allow the administrator to set and adjust organizational rules for allowing/preventing access to the organization network. Examples of graphical user interfaces that may be displayed by organizational risk assessment application 258 using display 260 are discussed below with references to FIGS. 7, 8 and 9.

The RAS 105, mobile device 115 and administrator computer 130 may have various additional components not shown in FIG. 2. For example, additional input or output devices (e.g., keyboard, pointing device, etc.) may be included beyond those shown in FIG. 2.

The local risk assessment application 218 may be a mobile application provided by the risk assessment server 105. A user of the mobile device 115 may download the local risk assessment application 218 from RAS 105 or through an app store such as the Apple App Store or Google Play.

Once the local risk assessment application 218 is installed on the mobile device, the local risk assessment application 218 may identify all mobile apps installed on the mobile device 115, including pre-installed and user installed apps. The local risk assessment application 218 may define an application identifier for each of the identified mobile apps.

The application identifier may include a plurality of identifying characteristics for a mobile app, the plurality of identifying characteristics enabling the RAS 105 to identify the app that is installed. The identifying characteristics may include further identifying details such as version and build numbers for a particular application. In some cases, the identifying characteristics may also include application characteristics for the mobile applications installed on the mobile device 115. Application characteristics generally reflect inherent operational characteristics of the applications installed on the mobile device 115.

The local risk assessment application 218 can also identify device-specific parameters for the mobile device 115. The device-specific parameters may include device-specific parameters for one or more of the mobile applications installed on mobile device 115. For example, the device-specific parameters for a mobile application may include the current permission settings granted to that mobile application on that particular mobile device 115. The device-specific parameters may include the current permission settings granted to each mobile application on the mobile device 115.

The local risk assessment application 218 may transmit the plurality of application identifiers and the device-specific parameters to the RAS 105. The RAS 105 may use the application identifiers and the device-specific parameters to determine application risk levels and device risk levels for the mobile device 115.

The RAS 105 may store a mobile application listing in database 238. The mobile application listing may include all the mobile applications the RAS 105 has previously identifier and/or analyzed. The mobile application listing may also include the application identifiers for each known mobile application. Accordingly, the RAS 105 may identify corresponding mobile applications on the mobile device 115 by matching the received application identifiers to corresponding application identifiers stored in the database 238.

The mobile application listing may also include a plurality of application characteristics for each of the known mobile applications in the mobile application listing. The application characteristics generally define inherent operational characteristics of the known mobile devices. The inherent operational characteristics refer to operational characteristics of the mobile applications that are expected or known to be consistent across a plurality of mobile devices 115 regardless of the settings of the mobile device 115. Examples of application characteristics include interaction with operating system levels, app behavior, app communication patterns (live time communication patterns, dynamic changes in URIs URLs), vulnerability monitoring, alerting data and trusted community feedback.

In some cases, the risk assessment server 105 may analyze one or more of the mobile applications identified. For example, the risk assessment server 105 may determine that an applications requires further analysis and download a copy of that mobile application. The risk assessment server 105 may then perform operational tests on the mobile application to determine additional application characteristics such as runtime behavior, normal communication patterns, operating system interaction levels, communicating locations (i.e. where the app is sending data) and so on. These additional application characteristics may then be stored in database 238. The risk engine may identify where the app is sending data in order to identify apps sending data to known malicious sites. The risk engine may also identify normal communication patterns for the app so that potentially dangerous patterns (communicating out of home country) and subsequent runtime changes in communication patterns (i.e. from a corrupted or counterfeit app) can be identified.

In some cases, an app may be flagged for further analysis based on an initial application risk level determination indicating a high risk app. Subsequent to the further analysis, the initial application risk level may be updated using the additional application characteristics.

In some embodiments, the local risk assessment application may perform an initial application risk assessment directly at the mobile device 115. The initial application risk assessment may be performed based on the device-specific parameters of mobile device 115, and application characteristics identifiable at the device 115. If the initial risk assessment indicates a potentially risky application, the RAS 105 may then download the app for further analysis.

The RAS 105 can determine a plurality of application risk factors for each of the mobile applications on a mobile device 115. The application risk factors can include at least one inherent application risk factor for the mobile application. The inherent application risk factor refers to a risk that is inherent in the application itself, rather than the configuration of the application on a particular mobile device 115 or the configuration of the mobile device 115. The inherent application risk factors are generally determined from the application characteristics for a particular application.

The inherent application risk factors may include, for example, the operating system level the app is interacting with, known app vulnerabilities, community trust scores, risky runtime behaviors, risky communication patterns, risky communication locations etc.

The application risk factors can also include device-specific risk factors. The device-specific risk factors generally refer to risks relating to the configuration or settings of a particular mobile device 115 or the configuration/settings of the application on the particular mobile device 115. In general the device-specific risk factors can be determined from the device-specific parameters received from a mobile device 115. Examples of device-specific risk factors may include an application permission setting, a device setting, a combination of multiple application permission settings, and a combination of an application permission setting and a device setting.

In some cases, the device specific risk factors may also take into account application characteristics and/or application risk factors. For example, the device-specific risk factors may also include a combination of an application permission setting and an application characteristics and/or a combinations of a device setting and an application characteristics. For example, a mobile application with a permission setting allowing the mobile application to access detailed location finding permissions can result in a higher risk level when the mobile application also has a permission setting permitting the application to know the phone state (phone ID, ability to match to identity information) and a permission setting that permits the application to create open sockets to the internet.

The RAS 105 may determine an application risk level using the plurality of application risk factors. For example, the plurality of application risk factors may be processed using an application risk model to determine the application risk level for the application. The application risk model may be stored in database 238. In general, the application risk model may be updated to reflect changes in the operations of mobile device 115, in network 110, or in behaviors of users or hackers. The application risk level may be determined as a score or rating using various scales or risk identifiers such as 0-10, 0-100, color scales (Red, Yellow, Green) etc.

The RAS 105 may also determine a device risk level for a particular mobile device 115. The device risk level may be determined based on the plurality of application risk levels for the applications installed on that mobile device 115.

The RAS 105 may transmit the application risk levels and/or device risk levels to the mobile device 115. The local risk assessment application 218 may then generate a GUI to display to the user of mobile device 115 the current risk levels and risk factors. These GUIs may provide the user of mobile device 115 with an accurate rating of the level of risk that is represented by each of their apps, along with an explanation of what the impact of those risks could be to the user and their data, and recommendations on corrective actions the user can take to protect themselves. Examples of such GUIs will be discussed below with reference to FIGS. 4, 5, 6A-6D.

The RAS 105 can also transmit the application risk levels and/or device risk levels for the mobile device(s) 115 to the administrator computer 130, e.g. using the organization risk assessment application. This may permit an administrator of an organizational network to control access to the network for the mobile devices 115. This may also permit the administrator computer 130 to trigger network protection responses to allow/deny access to the organizational network, or to override the determinations of the RAS 105.

In some cases, automated network protection responses may be performed directly by RAS 105 without requiring communication to the administrator computer 130. For example, a user of the administrator computer 130 may configure the RAS 105 to automatically deny network access to devices that are considered high-risk. The user may also establish a network acceptable threshold or level of risk, above which a mobile device 115 is considered high-risk. Accordingly, the RAS 105 may automatically prevent a high-risk device—e.g., a mobile device whose risk level exceeds the acceptable threshold—from accessing the organizational network.

For example, the RAS 105 may generate and/or revoke a certificate that indicates whether a mobile device 115 is currently authorized to access the organizational network. This automated generation/revocation of certificates may automate the granting and revoking of corporate network and data access. Thus, the RAS 105 may be configured to automatically certify/decertify devices for BYOD access without requiring an organizational administrator to determine which permissions, behaviors, geographic locations, etc., they do not wish to allow. Decertifying a mobile device for BYOD could result in automatic disconnection from corporate networks and/or the wiping of corporate data from the device. In some cases, the RAS 105 may also generate risk alerts/notifications to both corporate and mobile device users if the risk levels change for an application or a device.

In general, embodiments of the system 200 may provide improved app risk assessment for mobile device users. The RAS 105 may provide risk assessment feedback and advice relating to the apps on a mobile device 115 directly to that mobile device 115, after installation and at the time of installing a new app. This may facilitate the user's management of their personal risks. In turn, this may also reduce the burden on organizations of monitoring a plurality of mobile devices by placing the primary capability and responsibility for managing mobile devices onto the device owner.

The RAS 105 may also minimize the burden on the organization of capturing and storing data from individual users that may require precautions or protections if the data is private or confidential. For example, while device and application risk levels and other relevant meta data may be visible to administrators, the details of the specific apps installed on an individual user's mobile device may only be stored in the RAS 105 and not shared with the administrator. An administrator may know that a particular user's device risk level is high, or that a user's device has a certain number of high risk apps, but the organizational risk assessment application may prevent the administrator from identifying the specific apps installed on the user's device and thereby enhance user privacy. Similarly, the administrator may know that a specific app exists on a certain number of devices connected into their environment, without knowing exactly which devices (or the corresponding users) they are installed on. This may protect the user's privacy, and reduce the burden on the organization of doing so.

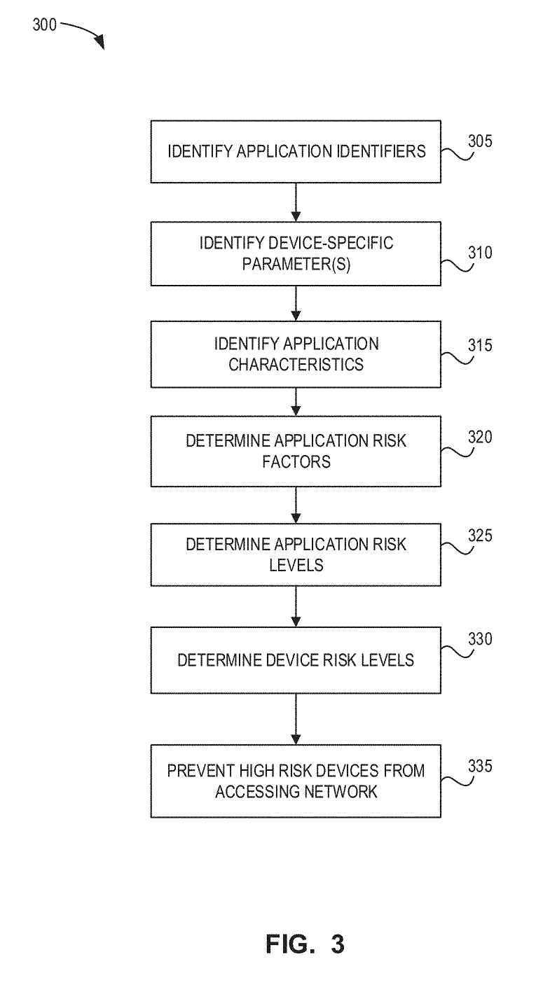

Referring now to FIG. 3, shown therein is a flowchart illustrating a method or process 300 of determining mobile device risk. Method 300 may be carried out by various components of system 200, such as the RAS 105 and the mobile device 115.

At 305, a plurality of application identifiers can be determined for a mobile device. Each application identifier identifies a mobile application installed on the mobile device. The local risk assessment application may also transmit the application identifiers to the RAS 105.

The plurality of application identifiers can be determined using a local risk assessment application installed on the mobile device 115. For instance, when the local risk assessment application is installed on the mobile device, the application may initiate a scan to identify all the apps installed on that device. The application may then determine application identifiers corresponding to the apps installed on that device.

The local risk assessment application may also monitor the apps installed on the device over time. If new applications are installed, or if applications are updated, then the device may transmit updated application identifiers to the RAS 105.

At 310, a plurality of device-specific parameters for the mobile device can be determined by the local risk assessment application. The device-specific parameters generally define operational characteristics for at least one of the mobile device and an application installed on the mobile device. For example, the device-specific parameters may include at least one application permission setting for the mobile device. In some cases, the device-specific parameters may include a plurality of application permission settings. An application permission setting defines a current permission for a particular mobile application on the mobile device.

The device-specific parameters may be identified as part of the initial scan of the device by the local risk assessment application. The local risk assessment application can also transmit the device-specific parameters to the RAS 105.

At 315, application characteristics for the mobile applications installed on the mobile device can be identified. The application characteristics generally define inherent operational characteristics of the mobile application.

In some cases, the application characteristics may be identified directly on the mobile device by the local risk assessment application. In some cases, the application characteristics may be identified by the RAS 105, for example using application identifiers received from the mobile device. The RAS 105 may store a database of application characteristics and use the application identifier as an index for the database. In some cases, the application characteristics may be determined by a combination of the local risk assessment application and the RAS 105. For example, the local risk assessment application may perform an initial analysis on the mobile device of the application characteristics. Subsequently, the RAS 105 may download a copy of the mobile application for further analysis and to identify additional application characteristics.

At 320 a plurality of application risk factors for a particular mobile application can be determined by the RAS 105. The application risk factors can include at least one inherent risk factor. The inherent risk factors can be determined form the application characteristics for the mobile application. In general, the inherent risk factors refer to risks associated with a mobile application regardless of the device on which the mobile application is running, the settings of the device pertaining to the application, or the settings of the device more generally. Examples of inherent risk factors may include an application runtime behavior, an operating system interaction, a known application vulnerability, and an application communication pattern.

The application risk factors can also include at least one device-specific risk factor. The device-specific risk factor can be determined from the plurality of device-specific parameters. For example, the device-specific risk factor may be determined as a high-risk combination of permissions for an application that includes at least two application permission settings.

In some cases, the device-specific risk factor may take into account both the device-specific parameters and application characteristics for a particular mobile applications on a particular device. For example, the device-specific risk factor may be determined as a high risk combination of one of the application permission settings and one of the application characteristics for the particular mobile application. In some cases, the RAS 105 may store a plurality of high-risk combinations (e.g. combination of permissions, other high-risk combinations of parameters and application characteristics) in database 238 and compare the device-specific parameters and application characteristics to the stored high-risk combinations to identify device-specific risk factors.

At 325, an application risk level can be determined by the RAS 105 for each mobile application installed on the mobile device. The application risk level can be determined based on the plurality of application risk factors for that mobile application. The application risk level may provide a general assessment of the risks to privacy and security posed by the application. The application risk level may be provided on a scale, such as a numerical or color scale to easily identify to a mobile device user and/or an administrator the risk level.

At 330, the RAS 105 may determine a device risk level for the mobile device, the device risk level can be determined based on the plurality of application risk levels determined for the mobile applications installed on that mobile device. For instance, the device risk level may be determined based on the highest risk application risk level for that device. In some cases, the device risk level may be determined by averaging the application risk levels, in some cases using a weighted average.

The RAS 105 may transmit the application risk levels and/or the device risk levels to the mobile device 115. The RAS 105 may also transmit additional risk data regarding the nature of the risks posed by particular apps, and even risk factor data for particular risk factors. Thus, the local risk assessment application may provide both summarized and detailed explanations of why an app is risky, what the impact could be, and steps that can be taken to mitigate the risks. This may motivate a user to uninstall a risky app from their device, or to adjust the device-specific parameters to reduce risks.

In some cases, the RAS 105 may also identify corrective actions to reduce the risk level of a particular application and/or the device as a whole. These corrective actions may also be displayed using the local risk assessment application to provide some direction to the user of how to reduce risk by adjusting device-specific parameters or uninstalling an app. For example, the corrective action may include modifying one of the application permission settings for an application with a high risk level.

A similar procedure may occur when a user attempts to install a new application. The local risk assessment application may identify the attempted installation. The local risk assessment application may then initiate an assessment of the potential risks of installing the application, and in some cases an assessment of permissible device-specific parameters to minimize the risk, prior to the application being installed on the mobile device.

The local risk assessment application may determine the application identifier for the new application and transmit the application identifier to the risk assessment server prior to the application being installed on the mobile device. The risk assessment server may determine a plurality of application characteristics for the new mobile application, e.g., based on information received from the local risk assessment application. The risk assessment server may also determine a plurality of potential application risk factors based on the application characteristics for the new mobile application, and determine a potential application risk level based on the potential application risk factors.

The risk assessment server may identify permissible device-specific parameters for the new application based on the plurality of potential application risk factors and the device risk level of the device. The permissible device-specific parameters may be determined taking into account an acceptable level of risk for the mobile device (e.g. a level of risk that must be maintained to access an organizational network). The permissible device-specific parameters may then be displayed in the local risk assessment application.

This can enable a user to make an informed decision about whether or not they wish to install the app in the first place (and before their device is compromised). This can also enable a user to make an informed decision regarding the device-specific parameters to be used in conjunction with the new mobile application. For instance, this may identify to the user application permission settings that they should not allow that otherwise they would have allowed.

The RAS 105 may also continually monitor changes to application characteristics, such as known application vulnerabilities. The RAS 105 may transmit a risk notification to the mobile device if new vulnerabilities have been identified that may affect the application risk level or device risk level on a mobile device.

In some cases, the mobile device may also attempt to access an organizational network. The RAS 105 may provide a gatekeeping function to determine whether a mobile device should be granted access to the network. The RAS 105 may interface with other mobile device management tools already in place in the organization to provide such a gatekeeping function.

At 335, the RAS 105 may prevent high risk devices from accessing the organizational network. For example, the organizational network may have established an acceptable level of network risk (a network acceptable risk level). Mobile devices having device risk levels greater than the network acceptable risk level may be identified as high risk devices. Accordingly, RAS 105 may prevent such high risk devices from access the organizational network.

The organizational network may also include an administrator computer with an organizational risk assessment application accessible thereto (e.g. as a cloud application or installed thereon). The organizational risk assessment application may enable an administrator of the organizational network to establish network access rules to be implemented by the RAS 105. For example, the network access rules may include the network acceptable risk level.

The organizational risk assessment application may also provide the administrator with an overview of mobile device access within the organizational network. The RAS 105 may transmit the application risk levels and/or the device risk levels for the various devices accessing and attempting to access the network to the administrator computer, to allow the organizational risk assessment application to provide this overview. However, the RAS 105 may limit the user-specific data transferred to the administrator computer to protect a user's privacy as discussed above. The RAS 105 may also transmit notifications to mobile users relating to any corrective actions required for their mobile devices to be providing with access to the organizational network.

The RAS 105 can also monitor modifications to the application characteristics and the device-specific parameters for applications installed on a particular mobile device. The RAS 105 may determine that a mobile device has an updated device risk level because of the modification. The RAS 105 can be configured to automatically trigger network protection actions if the updated device risk level is greater than the network acceptable risk level. In general, the network protection actions can at least partially restrict access to the organizational network for that mobile device while the updated device risk level is greater than the network acceptable risk level. These automated actions may provide enhanced security to the organizational network, without requiring an administrator to be notified of the change in risk level or to intervene. Examples of such automated actions may include removing the app from the mobile device, revoking or modifying app permissions, partially or fully blocking access to the organizational network. As mentioned above, the network protection actions may be triggered by interfacing with other mobile device management applications used by the organizational network.

The RAS 105 may also transmit notifications to the mobile device and/or the administrator computer when an updated device risk level is identified. These notifications to user may identify corrective actions for the user to reduce the updated device risk level, and to be re-certified to access the organizational network. Once the user has taken the corrective actions, the RAS 105 may again determine an updated device risk level, and may automatically approve the device to access the network if the updated device risk level is suitable. This may facilitate device risk management for an organization by requiring the user to take the primary responsibility for ensuring their device is secure.

Referring now to FIG. 4, shown therein is an example of a mobile risk assessment application display 400 in accordance with an embodiment. The display 400 is an example of a GUI that may be generated by a local risk assessment application 218 installed on a mobile device 115.

The GUI 400 shows an initial risk scanning display that a user of the mobile device 115 may be presented with when the local risk assessment application is first installed. Once installed, a user can use the local risk assessment application to scan the device 115 and identify all mobile apps installed on the device 115. As explained above, the local risk assessment application can also determine identifying characteristics for each of the installed apps, as well as device-specific parameters for the installed apps (and for mobile device 115 generally).

While GUI 400 represents an initial scanning operation display, the local risk assessment application can be configured to run automatically each time a user attempts to install a new app. This may allow the user to understand potential risks associated with the app prior to installing it. This may also allow the user to mitigate some risks prior to installing an app.

The local risk assessment application may in some cases identify an attempt to install a new mobile application. Prior to the new mobile application being installed on the mobile device, the local risk assessment application can determine an application identifier (and potential identifying characteristics) for the new mobile application. The local risk assessment application can then transmit the new application identifier to the risk assessment server for further analysis.

The risk assessment server can determine the plurality of application characteristics and in turn a plurality of potential application risk factors and potential application risk level for the new mobile application. The risk assessment server may also identify preventative actions to reduce the risk level for the new mobile application. For example, the risk assessment server may determine a plurality of permissible device-specific parameters intended to minimize the risk posed by the new mobile application. In general, preventative actions and corrective actions may be similar (or even the same), but the preventative actions may refer to actions taken before an application is installed, while corrective actions may refer to actions taken after an application is installed.

If the mobile device is part of an organizational network, the plurality of permissible device-specific parameters may be determined taking into account the network acceptable risk level. The permissible device-specific parameters may indicate to the user of the mobile device the acceptable settings for which the application can be used if the user wishes to continue to access the organizational network.

The local risk assessment application may then display the permissible device-specific parameters on the mobile device 115. This may inform the user of the restrictions on use of the mobile application.

In some cases, the risk assessment server may simply identify the potential application risk level, and associated potentially risky outcomes. The local risk assessment application can display the application risk level and/or the associated potentially risky outcomes to the user to provide the user with an indication of the risks posed by the mobile application. The user may then choose whether to install the application, or what settings to use, prior to installing this application. This may allow users to make less risky decisions about the apps they choose to install and leave on their devices, and suggest to users preventative actions that can be taken to configure their devices in ways that will better protect them.

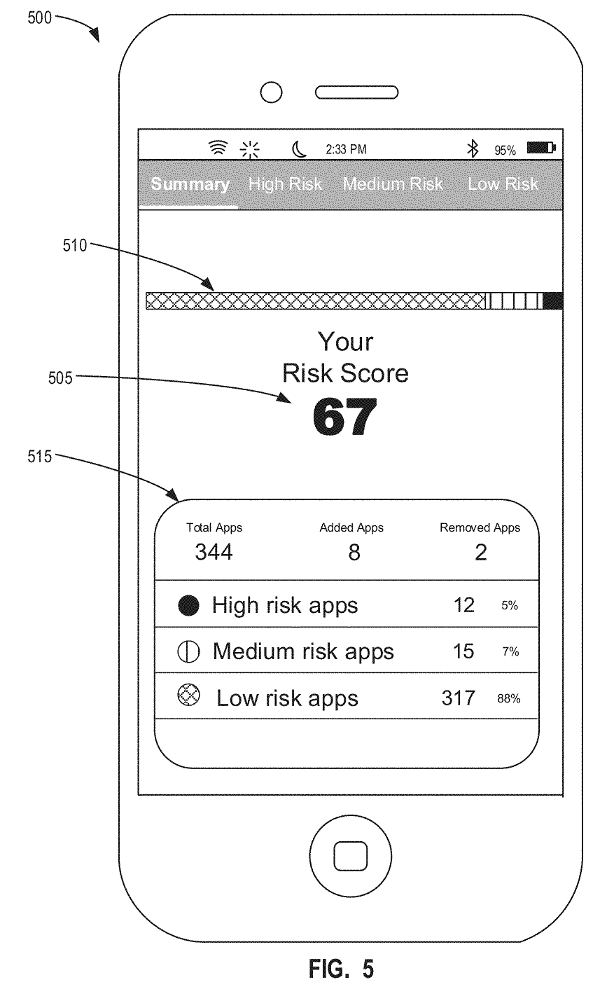

Referring now to FIG. 5, shown therein is an example of a mobile risk overview display 500 in accordance with an example embodiment. The display or GUI 500 may be shown by local risk assessment application on a mobile device to provide a user of the mobile device with summary information regarding the risks posed by the applications on the mobile device.

As mentioned above the risk assessment server may determine a plurality of application risk levels for the mobile applications installed on the mobile device. The risk assessment server may also identify a device risk level based on the plurality of application risk levels for the device. As shown in display 500, the application risk levels may be shown summarily as at 515 to indicate the relative number of applications having various application risk levels. The device risk level 505 may also be shown to the user to provide a quick overview of the risk posed to the device by the applications currently installed on the device. A risk score can be displayed in numerical form as at 505, and a graphical representation 510 of the risk level can also be displayed.

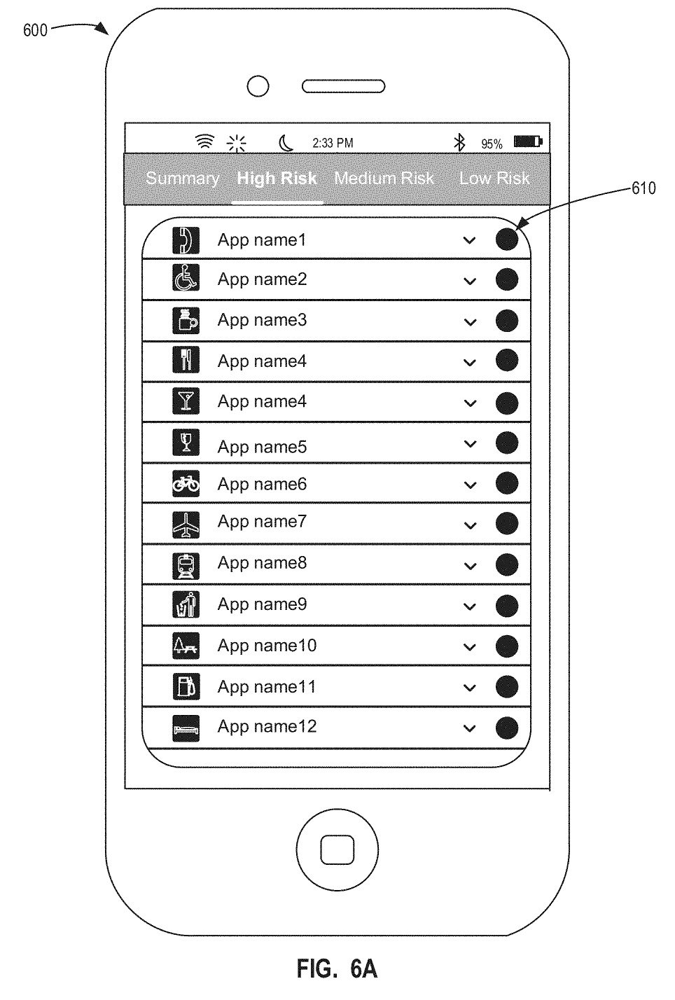

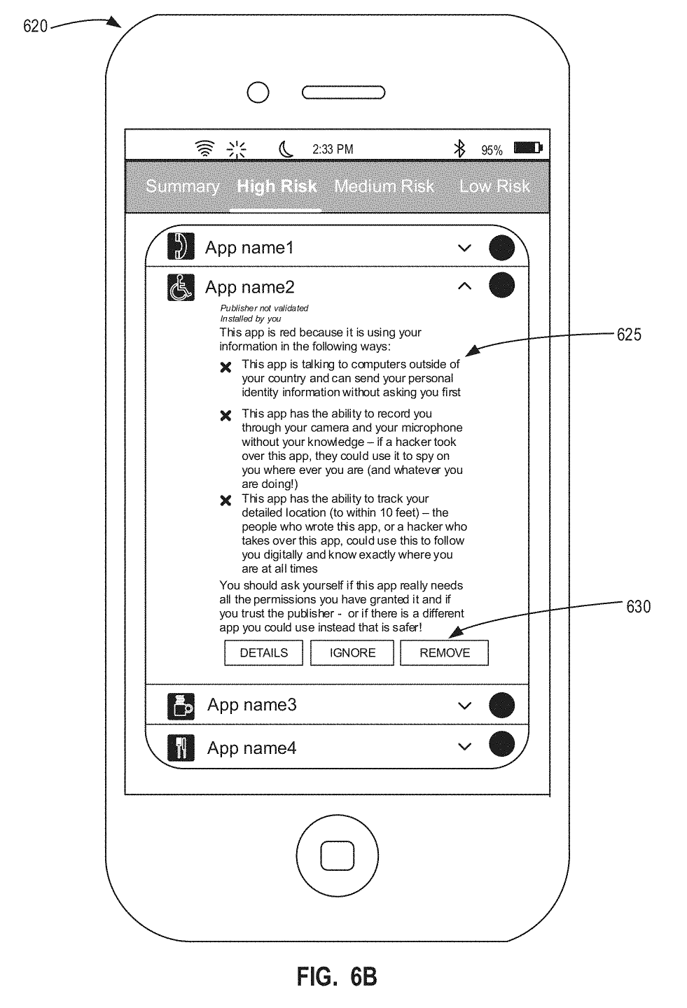

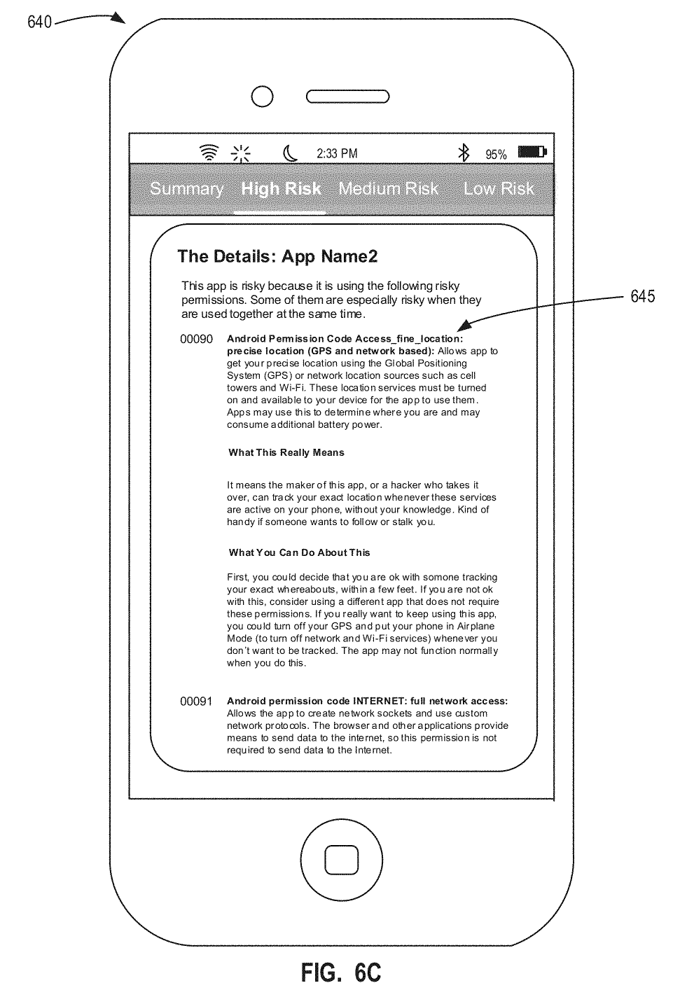

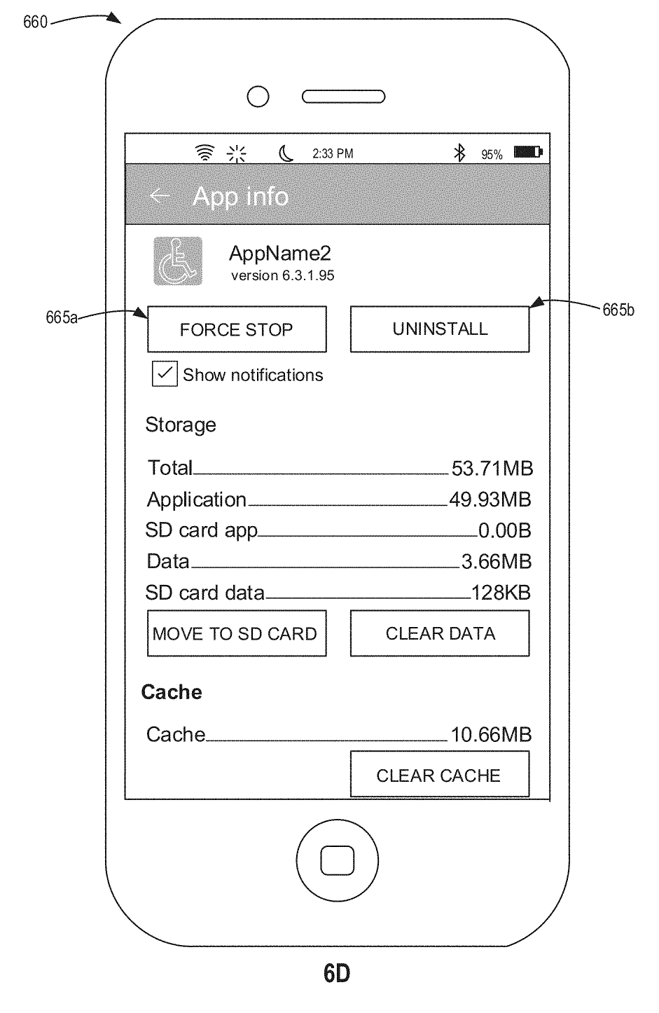

Referring now to FIG. 6A, shown therein is an example of an application risk overview display 600 in accordance with an example embodiment. GUI 600 provides a summary of application risk levels 610 for a plurality of the applications installed on the mobile device. As GUI 600 illustrates, the application risk level displays may be broken down into categories of risk levels, such as high risk, medium risk, and low risk. A user may select one of the applications listed in GUI 600 to access a detailed display of application risk information.

Referring now to FIG. 6B, shown therein is an example of an application risk factor display 620. The application risk factor display 620 displays a plurality of application risk factors 625 and associated risk factor details. The risk factor details may provide an explanation to the user of the risks caused by the application characteristics and the current device-specific parameters for a particular application.

The risk factor details may provide an initial description of why the app is considered risky, what the practical impact of these risks could be, and suggest some preventative or corrective actions that may be taken by a user of the device. The suggested actions may include corrective actions which can be initiated via corrective action controls 630, such as removing the device, as illustrated. A user may decide to uninstall an app from their device for various reasons, e.g. if they consider the risk factors to be too great, if the particular risk factors are undesirable, or if the presence of the app is preventing the mobile device user from connecting to a desired organizational network. The application risk factor display 620 may also provide a user with the option to review additional characteristics details explaining how the device-specific parameters and/or application characteristics contribute to the risk factors identified.

Referring now to FIG. 6C, shown therein is an example of a device-specific parameter display 640 in accordance with an embodiment. The device-specific parameter display 640 may identify to a user of the mobile device to view the device-specific parameters 645 that may contribute to the application risk factors, and in turn to higher application risk levels. The device-specific parameter display 640 can also explain how the device-specific parameters 645 may increase the application risk levels can encourage users of the mobile device to make informed decisions regarding the configuration of the mobile device.

Referring now to FIG. 6D, shown therein is an example of an application display 660 in accordance with an embodiment. The application display 660 may display to the user information associated with a particular application installed on the mobile device. In some cases, the display 660 may also include corrective action controls 665a and 665b that may be selected by the user to take corrective actions if the application risk level is greater than desired.

Referring now to FIG. 7, shown therein is an example of a network risk overview display 700 that may be displayed in accordance with an example embodiment. The network risk overview display 700 may form part of an organization risk portal that may be provided by the organizational risk viewer application 258.

The organizational risk portal may provide corporate users with the ability to control settings that determine which mobile devices are authorized for organizational network access and to execute other organizational risk management functions. For instance, the organizational risk portal may permit corporate users to modify the network acceptable risk level used to control access to the organizational network. The network risk overview display 700 may also provide an overview of the number of devices and users that are approved for network access and/or pending approval for network access.

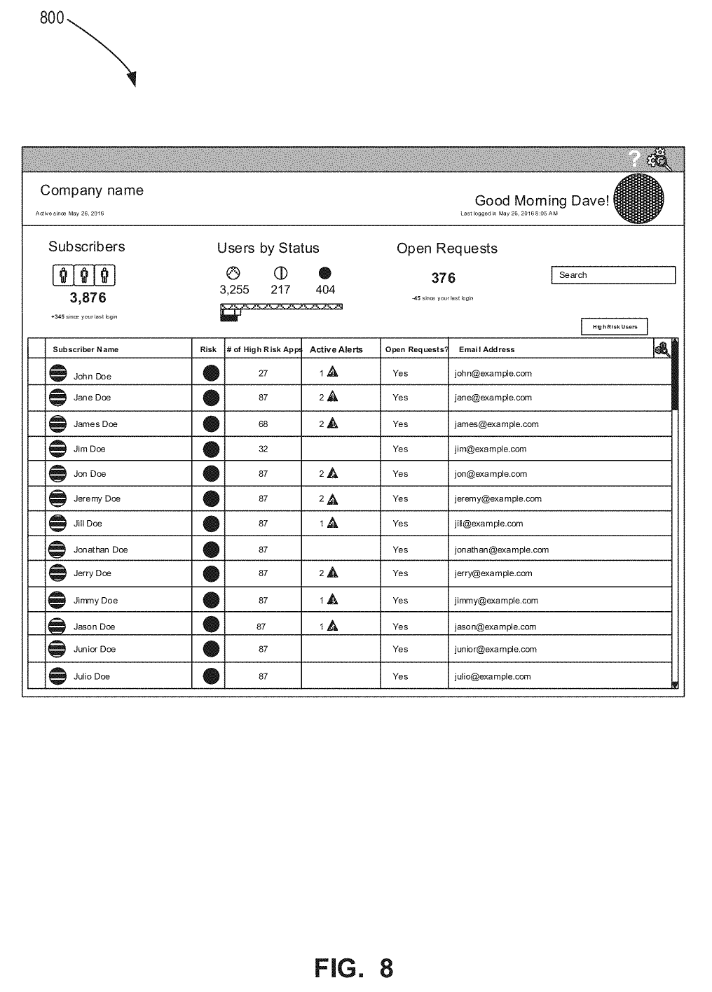

Referring now to FIG. 8, shown therein is an example user-specific risk overview display 800 in accordance with an embodiment. Display 800 identifies individual users (and in turn their associated mobile device) that have made requests to access the organizational network.

The display 800 provide a user-specific indication of the device risk level for each mobile device attempting to access the organizational network. The user-specific indication of device risk level may be provided to the corporate risk portal without specifically identifying the applications installed on the user's mobile device, or their current settings. This may provide some level of privacy protection for the users attempting to access the organizational network. This may also avoid additional privacy-related obligations on the part of the organization to protect the user's private information. The display 800 can also provide various additional information, such as the current status of particular mobile devices, and whether any changes or alerts are pending for a particular user. For example, an administrator may select an alert to open a display with additional information concerning the selected alert and, optionally, with corrective actions that can be taken.

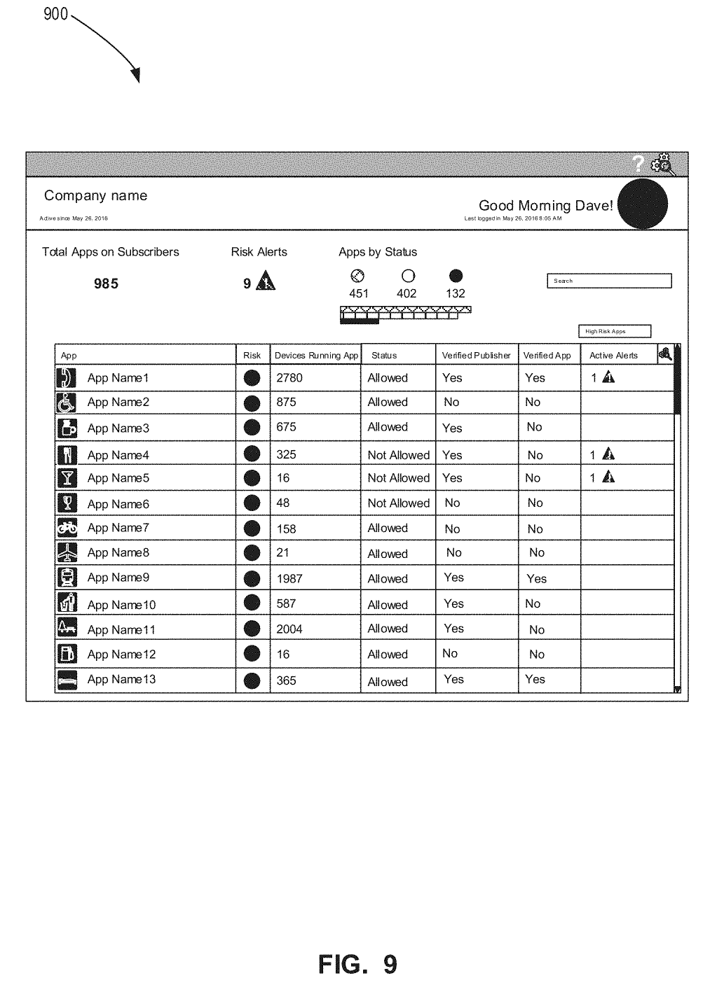

Referring now to FIG. 9, shown therein is an example application-specific risk overview display 900. The display 900 provides a corporate user with an overview of apps installed on devices accessing or attempting to access the organizational network. In the example shown in FIG. 9, display 900 is showing the riskiest apps installed on mobile devices in the organizational network.

In some cases, administrator users of the organizational portal may be permitted to modify application risk analysis settings on an application by application basis. For instance, if the organization itself generates apps that may be considered risky by the RAS 105, the corporate user may override the risk assessment provided by the RAS 105 by selecting an appropriate option from a contextual menu or other menu (not shown). Similarly, a corporate user may also override the RAS 105 to identify additional applications as being high-risk applications, or applications that automatically raise the device risk level above the network acceptable risk level. For instance, this may occur where the application is transmitted data to a country considered to be more likely to perform corporate espionage in the organization's industry.

The organizational portal also provides the administrator with the ability to drill down to view individual devices and apps (and associated risk levels) by selecting individual devices or apps in the user interface. However, the organizational portal may exclude the specific apps or data on an individual user's device.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

We claim:

1. A method of controlling mobile device access to an organizational network, the method comprising:
providing a risk assessment server for determining device risk, the risk assessment server comprising a processor and a memory and being in communication with a plurality of mobile devices associated with the organizational network;
providing a local risk assessment application to each of the mobile devices;
for each of the mobile devices, determining by the local risk assessment application
a plurality of application identifiers, each application identifier identifying a mobile application installed on that mobile device; and
a plurality of device-specific parameters, each device-specific parameter defining operational characteristics of at least one of the mobile device and an application on that mobile device;
receiving at the risk assessment server, from each mobile device, the plurality of application identifiers and the plurality of device-specific parameters determined by the local risk assessment application on that mobile device;
for each mobile device, determining by the risk assessment server
for each mobile application installed on that mobile device,
a plurality of application characteristics using the application identifiers, the application characteristics defining inherent operational characteristics of the mobile application;
a plurality of application risk factors for that mobile application, the plurality of application risk factors including at least one inherent application risk factor determined from the application characteristics of that mobile application and at least one device-specific risk factor determined from the plurality of device-specific parameters; and
an application risk level based on the plurality of application risk factors; and
a device risk level for that mobile device based on the plurality of application risk levels determined for the mobile applications installed on that mobile device;
determining a network acceptable risk level;
identifying at least one high-risk mobile device from the plurality of mobile devices, each high-risk mobile device having a device risk level greater than the network acceptable risk level; and
controlling access to the organizational network by preventing each high-risk mobile device from accessing the organizational network.

2. The method of claim 1, wherein the at least one inherent application risk factor comprises at least one of an application runtime behavior, an operating system interaction, a known application vulnerability, and an application communication pattern.

3. The method of claim 1, wherein the plurality of device-specific parameters comprise at least one application permission setting defining a current permission for a particular mobile application on that particular mobile device.

4. The method of claim 3, wherein the at least one application permission setting comprises a plurality of application permission settings and the at least one device-specific risk factor comprises a high-risk combination of permissions that includes at least two application permission settings from the plurality of application permission settings.

5. The method of claim 3, wherein the at least one device-specific risk factor comprises a high risk combination of one of the application permission settings and one of the application characteristics for the particular mobile application.

6. The method of claim 1, further comprising:
determining by the risk assessment server at least one corrective action for one of the high-risk mobile devices, the at least one corrective action being determined to reduce the device risk level for that high-risk mobile device to below the network acceptable risk level; and
displaying the least one corrective action in the local risk assessment application for that high-risk mobile device.

7. The method of claim 6, wherein the at least one corrective action comprises modifying an application permission setting for that high-risk mobile device.

8. The method of claim 1, further comprising:
identifying by the local risk assessment application on a particular mobile device an attempt to install a new mobile application;
prior to installation of the new mobile application, determining by the local risk assessment application the application identifier of the new mobile application, and transmitting the application identifier to the risk assessment server;
determining by the risk assessment server the plurality of application characteristics for the new mobile application;
determining by the risk assessment server a plurality of potential application risk factors for the new mobile application based on the application characteristics for the new mobile application, and determining a potential application risk level based on the plurality of potential application risk factors;
determining by the risk assessment server permissible device-specific parameters based on the plurality of potential application risk factors, the device risk level for that particular mobile device, and the network acceptable risk level; and
displaying the permissible device-specific parameters for the new mobile application in the local risk assessment application on the particular mobile device.

9. The method of claim 1, further comprising:
identifying by the local risk assessment application a modification to at least one of an application identifier and a device-specific parameter on a particular mobile device;
determining by the risk assessment server an updated device risk level for the particular mobile device based on the modification;
determining that the updated device risk level is greater than the network acceptable risk level; and
automatically triggering a network protection action for the particular mobile device, the network protection action at least partially restricting access to the organizational network for the particular mobile device while the updated device risk level is greater than the network acceptable risk level.

10. The method of claim 9, wherein the network protection action comprises at least one of automatically removing a particular mobile application installed on the particular mobile device, automatically modifying an application permission setting for the particular mobile application, and removing access to the organizational network for the particular mobile device.

11. The method of claim 1, further comprising:
providing an organizational risk assessment application to a remote administrator terminal; and
receiving at the risk assessment server an indication of the network acceptable risk level in response to an input to the organizational risk assessment application.

12. A method of providing a risk assessment for a mobile device, the method comprising:
providing a risk assessment server, the risk assessment server comprising a processor and a memory and being in communication with the mobile device;
providing a local risk assessment application to the mobile device;
determining by the local risk assessment application
a plurality of application identifiers, each application identifier identifying a mobile application installed on the mobile device; and
a plurality of device-specific parameters, each device-specific parameter defining operational characteristics of at least one of the mobile device and an application on that mobile device;
receiving the plurality of application identifiers and the plurality of device-specific parameters at the risk assessment server;
determining by the risk assessment server
for each mobile application installed on the mobile device,
a plurality of application characteristics defining inherent operational characteristics of the mobile application;
a plurality of application risk factors for that mobile application, the plurality of application risk factors including at least one inherent application risk factor determined from the application characteristics of that mobile application and at least one device-specific risk factor determined from the plurality of device-specific parameters; and
an application risk level based on the plurality of application risk factors; and
displaying in the local risk assessment application the plurality of application risk levels.

13. A network access control system comprising:
a remote administrator computer for an organizational network;
an organizational risk assessment application accessible to the remote administrator computer, the organizational risk assessment application configured to provide a user interface enabling a user of the remote administrator computer to define a network acceptable risk level for the organizational network;
a risk assessment server connected to the remote administrator computer and to a plurality of mobile devices associated with the organizational network, the risk assessment server comprising a memory, at least one network interface, and a server processor coupled to the memory for electronic communication therewith; and
a local risk assessment application installed on each of the mobile devices, the local risk assessment application comprising instructions for configuring a processor of the mobile device to
determine a plurality of application identifiers, each application identifier identifying a mobile application installed on that mobile device;
determine a plurality of device-specific parameters, each device-specific parameter defining operational characteristics of at least one of the mobile device and an application on that mobile device; and
transmit the plurality of application identifiers and the plurality of device-specific parameters to the risk assessment server;
wherein the processor of the risk assessment server is configured to determine, for each mobile device
for each mobile application installed on that mobile device,
a plurality of application characteristics, the application characteristics defining inherent operational characteristics of the mobile application;
a plurality of application risk factors for that mobile application, the plurality of application risk factors including at least one inherent application risk factor determined from the application characteristics of that mobile application and at least one device-specific risk factor determined from the plurality of device-specific parameters; and
an application risk level based on the plurality of application risk factors;
a device risk level for that mobile device based on the plurality of application risk levels determined for the mobile applications installed on that mobile device; and
wherein the server processor of the risk assessment server is further configured to:
identify at least one high-risk mobile device from the plurality of mobile devices, each high-risk mobile device having a device risk level greater than the network acceptable risk level; and
prevent each high-risk mobile device from accessing the organizational network.

14. The system of claim 13, wherein the at least one inherent application risk factor comprises at least one of an application runtime behavior, an operating system interaction, a known application vulnerability, and an application communication pattern.

15. The system of claim 13, wherein the plurality of device-specific parameters comprise at least one application permission setting defining a current permission for a particular mobile application on that particular mobile device.

16. The system of claim 15, wherein the at least one application permission setting comprises a plurality of application permission settings and the at least one device-specific risk factor comprises a high-risk combination of permissions that includes at least two application permission settings from the plurality of application permission settings.

17. The system of claim 15, wherein the at least one device-specific risk factor comprises a high risk combination of one of the application permission settings and one of the application characteristics for the particular mobile application.

18. The system of claim 13, wherein
the server processor of the risk assessment server is further configured to:
determine at least one corrective action for one of the high-risk mobile devices, the at least one corrective action being determined to reduce the device risk level for that high-risk mobile device to below the network acceptable risk level; and
the local risk assessment application further comprises instructions for configuring the processor of the mobile device to
display the least one corrective action in the local risk assessment application for that high-risk mobile device.

19. The system of claim 18, wherein the at least one corrective action comprises modifying an application permission setting for that high-risk mobile device.

20. The system of claim 13, wherein:
the local risk assessment application further comprises instructions for configuring the processor of the mobile device to
identify an attempt to install a new mobile application on that mobile device;
prior to installation of the new mobile application, determine the application identifier of the new mobile application and transmit the application identifier to the risk assessment server;
the server processor of the risk assessment server is further configured to
determine the plurality of application characteristics for the new mobile application;
determine a plurality of potential application risk factors for the new mobile application based on the application characteristics for the new mobile application;
determine a potential application risk level based on the plurality of potential application risk factors; and
determine permissible device-specific parameters based on the plurality of potential application risk factors, the device risk level for that particular mobile device, and the network acceptable risk level; and
the local risk assessment application further comprises instructions for configuring the processor of the mobile device to
display the permissible device-specific parameters.

21. The system of claim 13, wherein
the local risk assessment application further comprises instructions for configuring the processor of the mobile device to
identify a modification to at feast one of an application identifier and a device-specific parameter on a particular mobile device;
the server processor of the risk assessment server is further configured to
determine an updated device risk level for the particular mobile device based on the modification;
determine that the updated device risk level is greater than the network acceptable risk level; and
automatically trigger a network protection action for the particular mobile device, the network protection action at least partially restricting access to the organizational network for the particular mobile device while the updated device risk level is greater than the network acceptable risk level.

22. The system of claim 21, wherein the network protection action comprises at least one of automatically removing a particular mobile application installed on the particular mobile device, automatically modifying an application permission setting for the particular mobile application, and removing access to the organizational network for the particular mobile device.
